(19) United States
(12) Patent Application Publication
(10) Pub. No.: US 2007/0042763 A1
(43) Pub. Date: Feb. 22, 2007

(54) METHOD FOR SIMULATING AN INCOMING CALL ON A MOBILE PHONE

(76) Inventor: Sheng-En Yeh, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/307,883

(22) Filed: Feb. 27, 2006

(30) Foreign Application Priority Data
Aug. 17, 2005 (TW) 094128037

(51) Int. Cl. H04M 3/00

(52) U.S. Cl. 455/418; 455/423

(57) ABSTRACT

By setting in advance a waiting time and the content for displaying on a mobile phone, a simulation of an incoming call on the mobile phone is activated by a specific combination of key inputs. The incoming call can be simulated to accommodate various calling and responding situations according to user's preference.

### BACKGROUND OF THE INVENTION

1. Field of the Invention

The present invention relates to a simulation method, and more specifically, to a method for simulating an incoming call on a mobile phone.

2. Description of the Prior Art

Modern mobile communications technology has made communication between people easier. With a mobile phone at hand, anyone can be reached at anytime if his or her mobile phone is on. Hence, the “incoming call” has become unwelcome interrupter in some circumstances, such as during a meeting, concert, movie, or test, for example. On the other hand, the ability to receive an incoming call on a mobile phone can also serve as a method for a user to escape a situation with the excuse of answering the phone.

Generally, a mobile phone user must talk with other person in advance for making an expected phone call to get away from some annoying situation. However, it is difficult to contact with other person. Furthermore, there are a lot of uncertainties since the other person is a human being and miscommunications may happen. For example, other person may forget to call the user or miss the right time to call by just a few minutes.

### SUMMARY OF THE INVENTION

The claimed invention provides a method for simulating an incoming call on a mobile phone comprising inputting a predetermined input, and executing a simulated call on the mobile phone when detecting the predetermined input.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a setup stage of the method for simulating an incoming call on a mobile phone according to the present invention.

FIG. 2 is a flow chart of an execution stage of the method for simulating an incoming call on a mobile phone according to the present invention.

FIG. 3 is a flow chart of another exemplary embodiment of an execution stage of the method for simulating an incoming call on a mobile phone according to the present invention.

### DETAILED DESCRIPTION

Two stages are introduced according to the method for simulating an incoming call on a mobile phone according to the present invention: a setup stage and an execution stage.

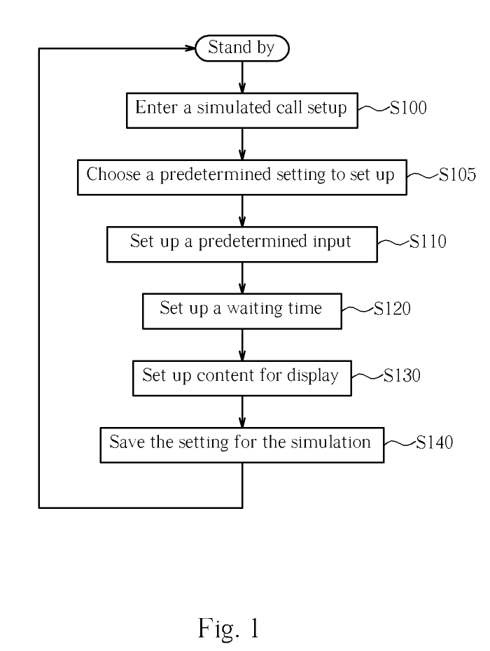

Please refer to FIG. 1, which is a flow chart of the setup stage. The setup stage includes the following steps:

Step S100: Enter a simulated call setup to set up the function for simulating an incoming call;

Step S110: Set up a predetermined input for activating the simulation;

Step S120: Set up a waiting time for the simulated call;

Step S130: Set up content for display on a screen of the mobile phone when executing the simulated call, the content being text, graphics, or animation;

Step S140: Save the setting for the simulation.

When applying the method for simulating an incoming call, first, the setup screen is entered to set up the function for simulating the incoming call. As steps S110˜S130 describe, the setup of the function for simulating the incoming call comprises setting up the predetermined input to activate the simulation, the waiting time for the simulated call, and the content for display on the screen of the mobile phone when executing the simulated call. For example, if the predetermined input in step S110 is “**2255#” (by a combination of key presses or a single button of the mobile phone), then the corresponding waiting time for the simulated call is one minute, the content for display on the screen when executing the simulated call is showing the number of the simulated call, and the function for the simulation is activated right after the combination of key presses “**2255#” is entered. The mobile phone will then display the number of the simulated call on the screen of the mobile phone, along with notifying the user by playing a ring tone, vibrating the mobile phone, or displaying light signals on the mobile phone one minute after the user inputs the combination of key presses.

More than one predetermined setting is allowed to exist in the setup stage of the present invention. Through different combinations of key presses in step S110, different presentations of the simulated call can be activated. In another case, a new step S105 takes place right after entering the setup stage in Step S100. According to step S105, among a plurality of predetermined settings one predetermined setting is chosen to be set up. In addition, according to the user's selection, the displayed content in step S130 can be either a phone number from a caller or a name ID of the caller, which is for the user to identify the simulated call and can be a made-up number or name. The number or name ID of the caller can be determined by the user and can be any values.

The steps S100˜S130 can be performed in any order and are not restricted by the exemplary embodiment of the present invention.

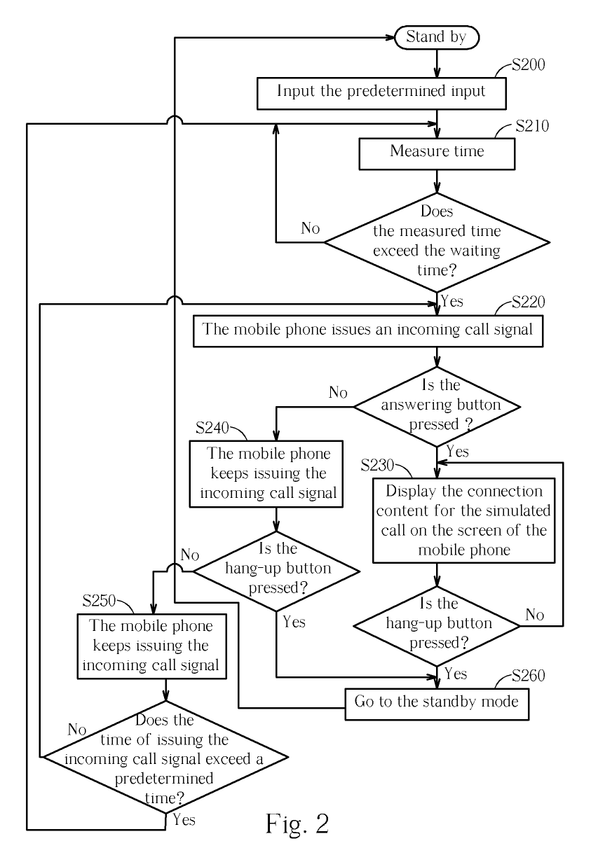

After finishing the setup stage, the simulation performs the execution stage when the predetermined input is inputted. Please refer to FIG. 2 for a flow chart in the execution stage. The execution stage includes the following steps:

Step S200: input the predetermined input;

Step S210: a timer measures time and check if the measured time exceeds the waiting time set in Step S120; if exceeded, Step S220 is executed;

Step S220: the mobile phone issues an incoming call signal and checks for a response signal (e.g. a press of the answering button on the mobile phone); on detection of the response signal, stop issuing the incoming call signal; otherwise, Step S240 is executed;

Step S230: display the connection content for the simulated call on the screen of the mobile phone and check for a disconnecting signal (e.g. a press of the hang-up button on the mobile phone); on detection of the disconnecting signal, stop displaying the connection content for the simulated call on the screen and execute Step S260; otherwise, repeat Step S230;

Step S240: the mobile phone keeps issuing the incoming call signal and checking for a disconnecting signal (e.g. a press of the hang-up button on the mobile phone); on detection of the disconnecting signal, stop issuing the incoming call signal and execute Step S260; otherwise, execute Step S250;

Step S250: the mobile phone keeps issuing the incoming call signal and checking if the time of issuing the incoming call signal exceeds the predetermined time; if exceeded, stop issuing the incoming call signal and execute Step S210; otherwise, execute Step S220;

Step S260: go to the standby mode.

When receiving the predetermined input of the combination of key presses, the mobile phone begins to issue a simulated call signal after the waiting time set in step S120. According to the previously made setting, the mobile phone notifies the user about the incoming call by playing a ring tone, vibrating, or displaying light signals, which can be played alone or played in combination. The user can also choose the mobile phone notification when simulating an incoming call from the default methods of notification provided by the mobile phone. Besides, the mobile phone issuing a simulated call further includes displaying content of the incoming call on the screen of the mobile phone. The content can be text, graphics, or animation along with the time about the incoming call to simulate a real incoming call.

After receiving the incoming call signal from the mobile phone issued, the mobile phone responds to different feedback accordingly. The mobile phone will execute a response function and stop issuing the incoming call signal according to a response signal which responds to the incoming call signal from the mobile phone, as steps S220˜S250 described. When receiving the incoming call signal, the user can answer the call, disconnect the call, or make no response until the incoming call stops itself. When the user answers the call by pressing the answering button on the phone, namely, issuing an accepting signal as in step S220 and step S230, the mobile phone stops issuing the incoming call signal and displays simulation content of connection, which can either be a phone number from a caller, a name ID of the caller, or the time duration of the incoming call that, these being set in step S130.

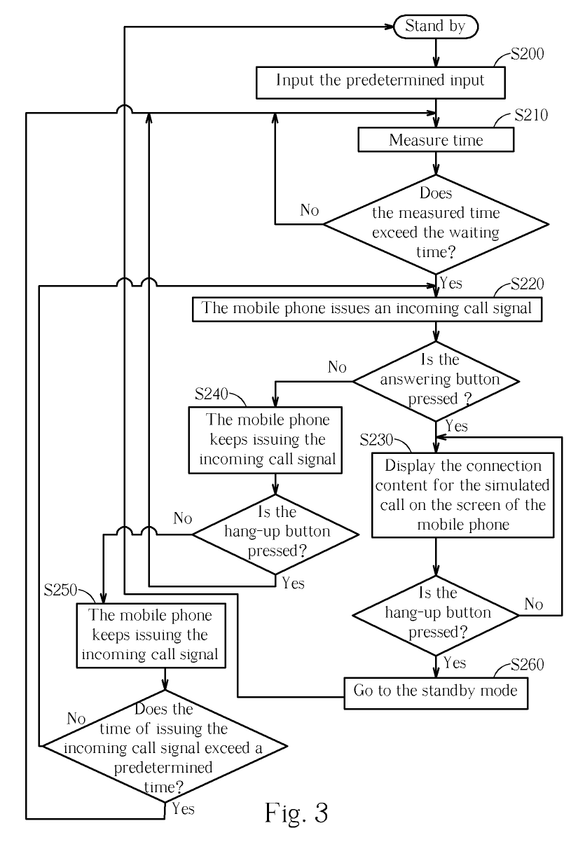

As in step S240, when the user disconnects the call, namely, the mobile phone issues a disconnecting signal as a response signal, the mobile phone stops issuing the incoming call signal and goes back to the standby stage. Another exemplary embodiment of the present invention provides an option of reissuing an incoming call signal and measuring time again after receiving a disconnecting signal in step S240. This option can be set in the setup stage of the method. Please refer to FIG. 3 for a flow chart of another exemplary embodiment of the execution stage of the present invention. In step S240, when the user gets the incoming call signal and activates a disconnecting signal by pressing the hang-up button on the mobile phone, step S210 will be executed and the simulation of an incoming call will reactivate and the timer will measure time again. The second waiting time need not be the same as the waiting time set in step S120. Therefore, in the present invention, a first waiting time and a second waiting time can be separately set in step S120, wherein the first waiting time is the waiting time of issuing the first simulated call as described above. If no second waiting time is set in step S120, the mobile phone can take the first waiting time as the second waiting time if needed. If the second waiting time is set in advance in step S120, the mobile phone can wait for as long as the second waiting time to reissue a second simulated call when the user disconnects the first simulated call in step 240. For example, if the second waiting time is shorter than the first waiting time, an urgent call can be simulated.

Please refer to FIG. 2. When the user receives the simulated incoming call on the mobile phone and makes no response in a default time, the mobile phone stops issuing the incoming call signal and goes back to step S210 to reactivate the simulation of incoming call and begins to measure the time, which need not be the same as the waiting time set in step S120. In another exemplary embodiment of the present invention, when the time duration of issuing the incoming call signal in step S250 exceeds the default time and the mobile phone stops issuing the incoming call signal, step S260 will be executed and the mobile phone will return to the standby stage (which is not shown in FIG. 2).

The method for simulating an incoming call on a mobile phone according to the present invention can issue a simulated call according to a user's need. However, the priority of a real incoming call will be higher than that of the simulated call. When the mobile phone receives a real incoming call when the simulation is executing, the method of the present invention will renew the content of the incoming call on the screen of the mobile phone to display the content about the real incoming call, preventing any possibility of missing a real incoming call during the simulation.

The method for simulating an incoming call according to the present invention performs the simulation by setting in advance a waiting time and the content for displaying on a mobile phone, and activating the simulation by a specific combination of key inputs. The incoming call can be simulated to accommodate various calling and responding situations according to the user's preference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for simulating an incoming call on a mobile phone, comprising:
inputting a predetermined input; and
executing a simulated call on the mobile phone when detecting the predetermined input.

2. The method of claim 1, further comprising setting up content for display on a screen of the mobile phone when executing the simulated call.

3. The method of claim 1, further comprising setting up the predetermined input.

4. The method of claim 1, further comprising setting up a waiting time for the simulated call.

5. The method of claim 4, wherein executing the simulated call on the mobile phone comprises:
comparing a waiting time with a time measured by a timer.

6. The method of claim 1, wherein executing the simulated call on the mobile phone comprises:
issuing an incoming call signal on the mobile phone.

7. The method of claim 6, wherein executing the simulated call on the mobile phone further comprises:
executing a response function according to a response signal which responds to the incoming call signal from the mobile phone;
wherein executing the response function comprises stopping issuing the incoming call signal on the mobile phone.

8. The method of claim 7, wherein executing the response function when the response signal is a disconnecting signal, further comprises:
waiting for a predetermined time after stopping issuing the incoming call signal on the mobile phone; and
issuing another incoming call signal on the mobile phone after the predetermined time.

9. The method of claim 7, wherein executing the response function further comprises displaying a simulation content of connection when the response signal is an accepting signal.

10. The method of claim 6, wherein executing the simulated call on the mobile phone further comprises stopping issuing the incoming call signal when a time that the mobile phone issues the incoming call signal exceeds a default time.

11. The method of claim 10, wherein executing the simulated call on the mobile phone further comprises:
waiting for a predetermined time after stopping issuing the incoming call signal; and
issuing another incoming call signal on the mobile phone after the predetermined time.

12. The method of claim 6, wherein issuing the incoming call signal of the mobile phone comprises displaying content of the incoming call on a screen of the mobile phone.

13. The method of claim 6, wherein issuing the incoming call signal of the mobile phone comprises playing a ring tone on the mobile phone.

14. The method of claim 6, wherein issuing the incoming call signal of the mobile phone comprises vibrating the mobile phone.

15. The method of claim 6, wherein issuing the incoming call signal on the mobile phone comprises displaying light signals on the mobile phone.

16. The method of claim 1, further comprising renewing the content of the incoming call on the screen of the mobile phone when the mobile phone receives a real incoming call during the execution of the simulated call.
